(19) United States
(12) Patent Application Publication
(10) Pub. No.: US 2025/0247542 A1
(43) Pub. Date: Jul. 31, 2025

(54) METHOD, APPARATUS, AND MEDIUM FOR VISUAL DATA PROCESSING

(71) Applicants: Douyin Vision Co., Ltd., Beijing (CN); Bytedance Inc., Los Angeles, CA (US)

(72) Inventors: Zhaobin ZHANG, Los Angeles, CA (US); Semih Esenlik, Los Angeles, CA (US); Yaojun Wu, Beijing (CN); Meng Wang, Beijing (CN); Kai Zhang, Los Angeles, CA (US); Li Zhang, Los Angeles, CA (US)

(21) Appl. No.: 19/185,048

(22) Filed: Apr. 21, 2025

Related U.S. Application Data
(63) Continuation of application No. PCT/CN2023/125774, filed on Oct. 20, 2023.

(30) Foreign Application Priority Data
Oct. 21, 2022 (WO) PCT/CN2022/126679

(51) Int. Cl. H04N 19/136; H04N 19/124; H04N 19/13; H04N 19/189; H04N 19/42; H04N 19/50

(52) U.S. Cl. CPC H04N 19/136; H04N 19/124; H04N 19/13; H04N 19/189; H04N 19/42; H04N 19/50

(57) ABSTRACT

Embodiments of the present disclosure provide a solution for visual data processing. A method for visual data processing is proposed. The method comprises: determining, for a conversion between visual data and a bitstream of the visual data, a target weight for use by a target module in a coding system based on information associated with the visual data, the coding system being implemented with at least one neural network; and performing the conversion by using the coding system based on the target weight.

### CROSS REFERENCE TO RELATED APPLICATIONS

This application is a continuation of International Application No. PCT/CN2023/125774, filed on Oct. 20, 2023, which claims the benefit of International Application No. PCT/CN2022/126679 filed on Oct. 21, 2022. The entire contents of these applications are hereby incorporated by reference in their entireties.

### FIELDS

Embodiments of the present disclosure relate generally to visual data processing techniques, and more particularly, to weight determination for a module in a coding system.

### BACKGROUND

Image/video compression is an essential technique to reduce the costs of image/video transmission and storage in a lossless or lossy manner. Image/video compression techniques can be divided into two branches, the classical video coding methods and the neural-network-based video compression methods. Classical video coding schemes adopt transform-based solutions, in which researchers have exploited statistical dependency in the latent variables (e.g., wavelet coefficients) by carefully hand-engineering entropy codes modeling the dependencies in the quantized regime. Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs. Coding efficiency of image/video coding is generally expected to be further improved.

### SUMMARY

Embodiments of the present disclosure provide a solution for visual data processing.

In a first aspect, a method for visual data processing is proposed. The method comprises: determining, for a conversion between visual data and a bitstream of the visual data, a target weight for use by a target module in a coding system based on information associated with the visual data, the coding system being implemented with at least one neural network; and performing the conversion by using the coding system based on the target weight. The method in accordance with the first aspect of the present disclosure determines a weight for a module in the coding system based on information associated with the visual data such as visual data content. In this way, the performance of the module can be improved. The coding effectiveness and coding efficiency of the coding system can thus be improved.

In a second aspect, an apparatus for visual data processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for visual data processing. The method comprises: determining a target weight for use by a target module in a coding system based on information associated with the visual data, the coding system being implemented with at least one neural network; and generating the bitstream by using the coding system based on the target weight.

In a fifth aspect, a method for storing a bitstream of a video is proposed. The method comprises: determining a target weight for use by a target module in a coding system based on information associated with the visual data, the coding system being implemented with at least one neural network; generating the bitstream by using the coding system based on the target weight; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example visual data coding system, in accordance with some embodiments of the present disclosure;

FIG. 2 illustrates an illustration of a typical transform coding scheme;

FIG. 3 illustrates an image from the Kodak dataset and different representations of the image;

FIG. 4 illustrates a network architecture of an autoencoder implementing the hyperprior model;

FIG. 5 illustrates a block diagram of a combined model, which jointly optimizes an autoregressive component that estimates the probability distributions of latents from their causal context (Context Model) along with a hyperprior and the underlying autoencoder;

FIG. 6 illustrates an encoding process;

FIG. 7 illustrates a decoding process;

FIG. 8 illustrates a decoding process with independent subnetwork weight selection for synthesis network;

FIG. 9 illustrates a flowchart of a method for visual data processing in accordance with embodiments of the present disclosure; and

FIG. 10 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

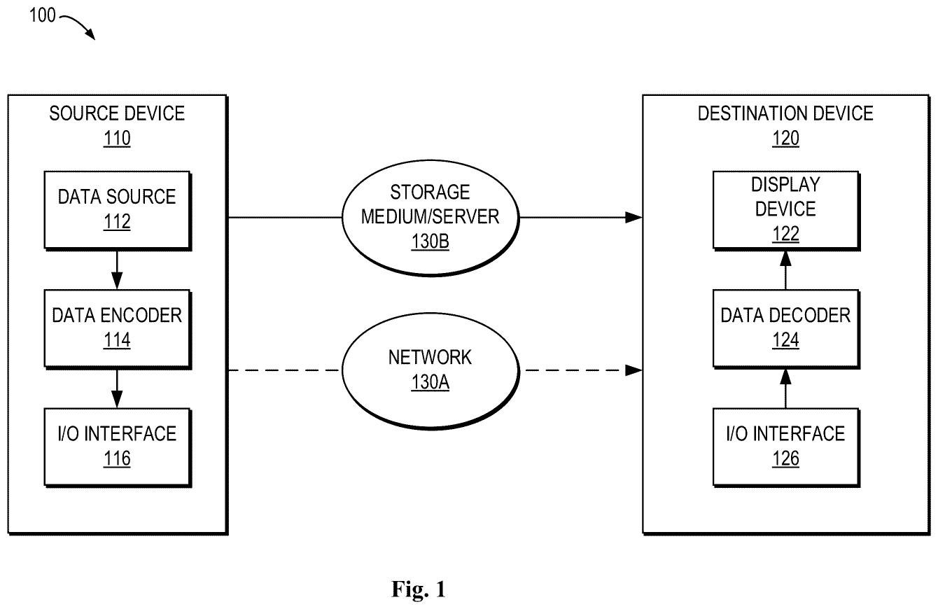

FIG. 1 is a block diagram that illustrates an example visual data coding system 100 that may utilize the techniques of this disclosure. As shown, the visual data coding system 100 may include a source device 110 and a destination device 120. The source device 110 can be also referred to as a data encoding device or a visual data encoding device, and the destination device 120 can be also referred to as a data decoding device or a visual data decoding device. In operation, the source device 110 can be configured to generate encoded visual data and the destination device 120 can be configured to decode the encoded visual data generated by the source device 110. The source device 110 may include a data source 112, a data encoder 114, and an input/output (I/O) interface 116.

The data source 112 may include a source such as a data capture device. Examples of the data capture device include, but are not limited to, an interface to receive data from a data provider, a computer graphics system for generating data, and/or a combination thereof.

The data may comprise one or more pictures of a video or one or more images. The data encoder 114 encodes the data from the data source 112 to generate a bitstream. The bitstream may include a sequence of bits that form a coded representation of the data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded data may be transmitted directly to destination device 120 via the I/O interface 116 through the network 130A. The encoded data may also be stored onto a storage medium/server 130B for access by destination device 120.

The destination device 120 may include an I/O interface 126, a data decoder 124, and a display device 122. The I/O interface 126 may include a receiver and/or a modem. The I/O interface 126 may acquire encoded data from the source device 110 or the storage medium/server 130B. The data decoder 124 may decode the encoded data. The display device 122 may display the decoded data to a user. The display device 122 may be integrated with the destination device 120, or may be external to the destination device 120 which is configured to interface with an external display device.

The data encoder 114 and the data decoder 124 may operate according to a data coding standard, such as video coding standard or still picture coding standard and other current and/or further standards.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific data codecs, the disclosed techniques are applicable to other coding technologies also. Furthermore, while some embodiments describe coding steps in detail, it will be understood that corresponding steps decoding that undo the coding will be implemented by a decoder. Furthermore, the term data processing encompasses data coding or compression, data decoding or decompression and data transcoding in which data are represented from one compressed format into another compressed format or at a different compressed bitrate.

### 1. Brief Summary

A neural network-based image and video compression method comprising an auto-regressive subnetwork, an entropy coding engine. In this disclosure, an independent subnetwork weight selection scheme for neural network-based image and video compression is presented. In the decoding process, the synthesis or the prediction network could be selected from a set of pretrained network weights instead of using a single specific subnetwork.

### 2. Introduction

The past decade has witnessed the rapid development of deep learning in a variety of areas, especially in computer vision and image processing. Inspired from the great success of deep learning technology to computer vision areas, many researchers have shifted their attention from conventional image/video compression techniques to neural image/video compression technologies. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable R-D performance with Versatile Video Coding (VVC), the latest video coding standard developed by Joint Video Experts Team (JVET) with experts from motion picture experts group (MPEG) and Video coding experts group (VCEG). With the performance of neural image compression continually being improved, neural network-based video compression has become an actively developing research area. However, neural network-based video coding still remains in its infancy due to the inherent difficulty of the problem.

### 2.1. Image/Video Compression

Image/video compression usually refers to the computing technology that compresses image/video into binary code to facilitate storage and transmission. The binary codes may or may not support losslessly reconstructing the original image/video, termed lossless compression and lossy compression. Most of the efforts are devoted to lossy compression since lossless reconstruction is not necessary in most scenarios. Usually the performance of image/video compression algorithms is evaluated from two aspects, i.e., compression ratio and reconstruction quality. Compression ratio is directly related to the number of binary codes, the less the better; Reconstruction quality is measured by comparing the reconstructed image/video with the original image/video, the higher the better. Image/video compression techniques can be divided into two branches, the classical video coding methods and the neural-network-based video compression methods. Classical video coding schemes adopt transform-based solutions, in which researchers have exploited statistical dependency in the latent variables (e.g., discrete cosine transform (DCT) or wavelet coefficients) by carefully hand-engineering entropy codes modeling the dependencies in the quantized regime. Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs.

In the last three decades, a series of classical video coding standards have been developed to accommodate the increasing visual content. The international standardization organizations ISO/IEC has two expert groups namely Joint Photographic Experts Group (JPEG) and Moving Picture Experts Group (MPEG), and ITU-T also has its own Video Coding Experts Group (VCEG) which is for standardization of image/video coding technology. The influential video coding standards published by these organizations include JPEG, JPEG 2000, H.262, H.264/AVC and H.265/HEVC. After H.265/HEVC, the Joint Video Experts Team (JVET) formed by MPEG and VCEG has been working on a new video coding standard Versatile Video Coding (VVC). The first version of VVC was released in July 2020. An average of 50% bitrate reduction is reported by VVC under the same visual quality compared with HEVC.

Neural network-based image/video compression is not a new invention since there were a number of researchers working on neural network-based image coding. But the network architectures were relatively shallow, and the performance was not satisfactory. Benefit from the abundance of data and the support of powerful computing resources, neural network-based methods are better exploited in a variety of applications. At present, neural network-based image/video compression has shown promising improvements, confirmed its feasibility. Nevertheless, this technology is still far from mature and a lot of challenges need to be addressed.

### 2.2. Neural Networks

Neural networks, also known as artificial neural networks (ANN), are the computational models used in machine learning technology which are usually composed of multiple processing layers and each layer is composed of multiple simple but non-linear basic computational units. One benefit of such deep networks is believed to be the capacity for processing data with multiple levels of abstraction and converting data into different kinds of representations. Note that these representations are not manually designed; instead, the deep network including the processing layers is learned from massive data using a general machine learning procedure. Deep learning eliminates the necessity of handcrafted representations, and thus is regarded useful especially for processing natively unstructured data, such as acoustic and visual signal, whilst processing such data has been a longstanding difficulty in the artificial intelligence field.

### 2.3. Neural Networks for Image Compression

Existing neural networks for image compression methods can be classified in two categories, i.e., pixel probability modeling and auto-encoder. The former one belongs to the predictive coding strategy, while the latter one is the transform-based solution. Sometimes, these two methods are combined together in literature.

### 2.3.1 Pixel Probability Modeling

According to Shannon's information theory, the optimal method for lossless coding can reach the minimal coding rate—log₂ p(x) where p(x) is the probability of symbol x. A number of lossless coding methods were developed in literature and among them arithmetic coding is believed to be among the optimal ones. Given a probability distribution p(x), arithmetic coding ensures that the coding rate to be as close as possible to its theoretical limit—log₂ p(x) without considering the rounding error. Therefore, the remaining problem is to how to determine the probability, which is however very challenging for natural image/video due to the curse of dimensionality. Following the predictive coding strategy, one way to model p(x) is to predict pixel probabilities one by one in a raster scan order based on previous observations, where x is an image.

$$p ( x ) = p ( {x}_{1} ) p ( {x}_{2} \vert {x}_{1} ) … p ( {x}_{i} \vert {x}_{1} , … , {x}_{i - 1} ) … p ( {x}_{m \times n} \vert {x}_{1} , … , {{x}_{m \times n}}_{- 1} ) \qquad ( 1 )$$

where m and n are the height and width of the image, respectively. The previous observation is also known as the context of the current pixel. When the image is large, it can be difficult to estimate the conditional probability, thereby a simplified method is to limit the range of its context.

$$p ( x ) = p ( {x}_{1} ) p ( {x}_{2} \vert {x}_{1} ) … p ( {x}_{i} \vert {x}_{i - k} , … , {x}_{i - 1} ) … p ( {x}_{m \times n} \vert {x}_{m \times n - k} , … , {{x}_{m \times n}}_{- 1} ) \qquad ( 2 )$$

where k is a pre-defined constant controlling the range of the context.

It should be noted that the condition may also take the sample values of other color components into consideration. For example, when coding the RGB color component, R sample is dependent on previously coded pixels (including R/G/B samples), the current G sample may be coded according to previously coded pixels and the current R sample, while for coding the current B sample, the previously coded pixels and the current R and G samples may also be taken into consideration.

Neural networks were originally introduced for computer vision tasks and have been proven to be effective in regression and classification problems. Therefore, it has been proposed using neural networks to estimate the probability of p(xᵢ) given its context x₁, x₂, . . . , xᵢ₋₁. In, the pixel probability is proposed for binary images, i.e., xᵢ∈{−1, +1}. The neural autoregressive distribution estimator (NADE) is designed for pixel probability modeling, where is a feed-forward network with a single hidden layer. A similar work is presented, where the feed-forward network also has connections skipping the hidden layer, and the parameters are also shared. NADE is extended to a real-valued model RNADE, where the probability p(xᵢ|x₁, . . . , xᵢ₋₁) is derived with a mixture of Gaussians. Their feed-forward network also has a single hidden layer, but the hidden layer is with rescaling to avoid saturation and uses rectified linear unit (ReLU) instead of sigmoid. NADE and RNADE are improved by using reorganizing the order of the pixels and with deeper neural networks.

Designing advanced neural networks plays an important role in improving pixel probability modeling. Multi-dimensional long short-term memory (LSTM) is proposed, which is working together with mixtures of conditional Gaussian scale mixtures for probability modeling. LSTM is a special kind of recurrent neural networks (RNNs) and is proven to be good at modeling sequential data. The spatial variant of LSTM is used for images. Several different neural networks are studied, including RNNs and CNNs namely PixelRNN and PixelCNN, respectively. In PixelRNN, two variants of LSTM, called row LSTM and diagonal BiLSTM are proposed, where the latter is specifically designed for images. PixelRNN incorporates residual connections to help train deep neural networks with up to 12 layers. In PixelCNN, masked convolutions are used to suit for the shape of the context. Comparing with previous works, PixelRNN and PixelCNN are more dedicated to natural images: they consider pixels as discrete values (e.g., 0, 1 . . . 255) and predict a multinomial distribution over the discrete values; they deal with color images in RGB color space; they work well on large-scale image dataset ImageNet. Gated PixelCNN is proposed to improve the PixelCNN, and achieves comparable performance with PixelRNN but with much less complexity. PixelCNN++ is proposed with the following improvements upon PixelCNN: a discretized logistic mixture likelihood is used rather than a 256-way multinomial distribution; down-sampling is used to capture structures at multiple resolutions; additional short-cut connections are introduced to speed up training; dropout is adopted for regularization; RGB is combined for one pixel. PixelSNAIL is proposed, in which casual convolutions are combined with self-attention. Most of the above methods directly model the probability distribution in the pixel domain. Some researchers also attempt to model the probability distribution as a conditional one upon explicit or latent representations. That being said, it may estimate

$$p ( x \vert h ) = {\prod }_{i = 1}^{m \times n} p ( {x}_{i} \vert {x}_{1} , … , {x}_{i - 1} , h ) \qquad ( 3 )$$

where h is the additional condition and p(x)=p(h)p(x|h), meaning the modeling is split into an unconditional one and a conditional one. The additional condition can be image label information or high-level representations.

### 2.3.2 Auto-Encoder

Auto-encoder is proposed. The method for the auto-encoder is trained for dimensionality reduction and consists of two parts: encoding and decoding. The encoding part converts the high-dimension input signal to low-dimension representations, typically with reduced spatial size but a greater number of channels. The decoding part attempts to recover the high-dimension input from the low-dimension representation. Auto-encoder enables automated learning of representations and eliminates the need of hand-crafted features, which is also believed to be one of the most important advantages of neural networks.

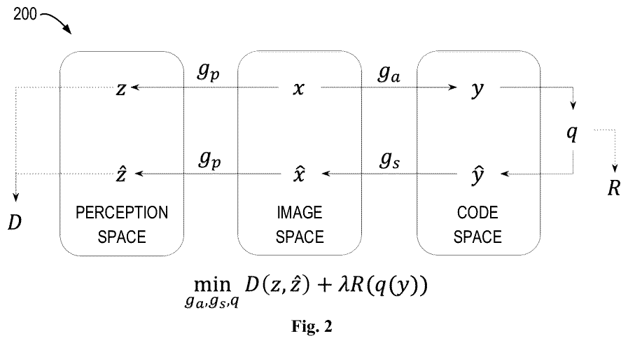

FIG. 2 illustrates an illustration of a typical transform coding scheme 200. The original image x is transformed by the analysis network gₐ to achieve the latent representation y. The latent representation y is quantized and compressed into bits. The number of bits R is used to measure the coding rate. The quantized latent representation ŷ is then inversely transformed by a synthesis network gₛ to obtain the reconstructed image x. The distortion is calculated in a perceptual space by transforming x and \hat{x} with the function gₚ.

It is intuitive to apply auto-encoder network to lossy image compression. The learned latent representation may be encoded from the well-trained neural networks. However, it is not trivial to adapt auto-encoder to image compression since the original auto-encoder is not optimized for compression thereby not efficient by directly using a trained auto-encoder. In addition, there exist other major challenges: First, the low-dimension representation should be quantized before being encoded, but the quantization is not differentiable, which is required in backpropagation while training the neural networks. Second, the objective under compression scenario is different since both the distortion and the rate need to be take into consideration. Estimating the rate is challenging. Third, a practical image coding scheme needs to support variable rate, scalability, encoding/decoding speed, interoperability. In response to these challenges, a number of researchers have been actively contributing to this area.

The prototype auto-encoder for image compression is in FIG. 2, which can be regarded as a transform coding strategy. The original image x is transformed with the analysis network y=gₐ(x), where y is the latent representation which will be quantized and coded. The synthesis network will inversely transform the quantized latent representation ŷ back to obtain the reconstructed image \hat{x}=gₛ(ŷ). The framework is trained with the rate-distortion loss function, i.e., L=D+λR, where D is the distortion between x and \hat{x}, R is the rate calculated or estimated from the quantized representation ŷ, and λ is the Lagrange multiplier. It should be noted that D can be calculated in either pixel domain or perceptual domain. All existing research works follow this prototype and the difference might only be the network structure or loss function.

In terms of network structure, RNNs and CNNs are the most widely used architectures. In the RNNs relevant category, a general framework for variable rate image compression using RNN is proposed. Binary quantization is used to generate codes and do not consider rate during training. The framework indeed provides a scalable coding functionality, where RNN with convolutional and deconvolution layers is reported to perform decently. An improved version by upgrading the encoder with a neural network similar to PixelRNN to compress the binary codes is then proposed. The performance is reportedly better than JPEG on Kodak image dataset using MS-SSIM evaluation metric. The RNN-based solution is further improved by introducing hidden-state priming. In addition, an SSIM-weighted loss function is also designed, and spatially adaptive bitrates mechanism is enabled. They achieve better results than BPG on Kodak image dataset using MS-SSIM as evaluation metric. Spatially adaptive bitrates are supported by training stop-code tolerant RNNs.

A general framework for rate-distortion optimized image compression is proposed. The use multiary quantization to generate integer codes and consider the rate during training, i.e. the loss is the joint rate-distortion cost, which can be MSE or others. They add random uniform noise to stimulate the quantization during training and use the differential entropy of the noisy codes as a proxy for the rate. They use generalized divisive normalization (GDN) as the network structure, which consists of a linear mapping followed by a nonlinear parametric normalization. The effectiveness of GDN on image coding is verified. An improved version is then proposed, where they use 3 convolutional layers each followed by a down-sampling layer and a GDN layer as the forward transform. Accordingly, they use 3 layers of inverse GDN each followed by an up-sampling layer and convolution layer to stimulate the inverse transform. In addition, an arithmetic coding method is devised to compress the integer codes. The performance is reportedly better than JPEG and JPEG 2000 on Kodak dataset in terms of MSE. Furthermore, they improve the method by devising a scale hyper-prior into the auto-encoder. They transform the latent representation y with a subnet hₐ to z=hₐ(y) and z will be quantized and transmitted as side information. Accordingly, the inverse transform is implemented with a subnet hₛ attempting to decode from the quantized side information \hat{z} to the standard deviation of the quantized ŷ, which will be further used during the arithmetic coding of ŷ. On the Kodak image set, their method is slightly worse than BPG in terms of PSNR. D. The structures are further exploited in the residue space by introducing an autoregressive model to estimate both the standard deviation and the mean. Z. Gaussian mixture model is used to further remove redundancy in the residue. The reported performance is on par with VVC on the Kodak image set using PSNR as evaluation metric.

### 2.3.3 Hyper Prior Model

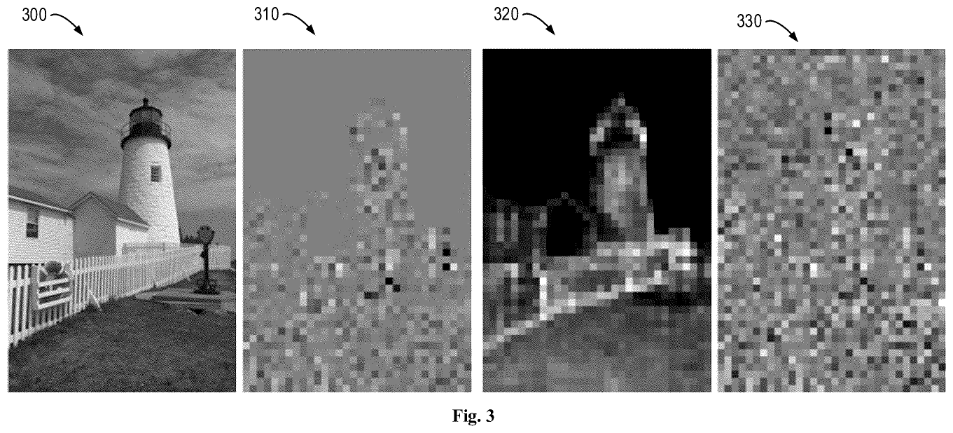

FIG. 3 illustrates example latent representations of an image, including an image 300 from the Kodak dataset, a visualization of the latent 310 representation y of the image 300, a standard deviations σ 320 of the latent 310, and latents y 330 after a hyper prior network is introduced. A hyper prior network includes a hyper encoder and decoder. In the transform coding approach to image compression, the encoder subnetwork (section 2.3.2) transforms the image vector x using a parametric analysis transform gₐ(x, Ø_{g}) into a latent representation y, which is then quantized to form ŷ. Because ŷ is discrete-valued, it can be losslessly compressed using entropy coding techniques such as arithmetic coding and transmitted as a sequence of bits.

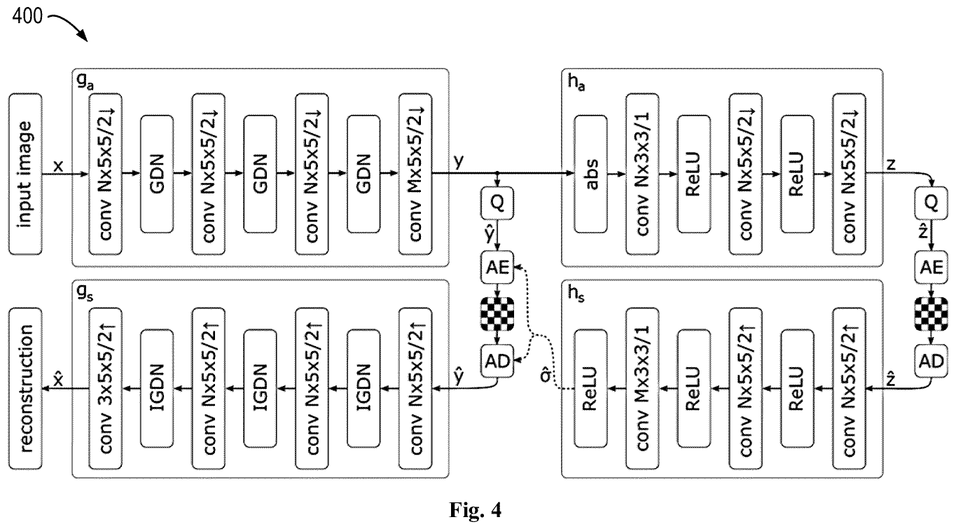

As evident from the latent 310 and the standard deviations σ 320 of FIG. 3, there are significant spatial dependencies among the elements of ŷ. Notably, their scales (middle right image) appear to be coupled spatially. An additional set of random variables \hat{z} are introduced to capture the spatial dependencies and to further reduce the redundancies. In this case the image compression network is depicted in FIG. 4.

FIG. 4 is a schematic diagram 400 illustrating an example network architecture of an autoencoder implementing a hyperprior model. The upper side shows an image autoencoder network, and the lower side corresponds to the hyperprior subnetwork. The analysis and synthesis transforms are denoted as gₐ and gₐ. Q represents quantization, and AE, AD represent arithmetic encoder and arithmetic decoder, respectively. The hyperprior model includes two subnetworks, hyper encoder (denoted with hₐ) and hyper decoder (denoted with hₛ). The hyper prior model generates a quantized hyper latent (\hat{z}) which comprises information related to the probability distribution of the samples of the quantized latent ŷ. \hat{z} is included in the bitstream and transmitted to the receiver (decoder) along with ŷ.

In FIG. 4, the left hand of the models is the encoder gₐ and decoder gₛ (explained in section 2.3.2). The right-hand side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses it to compress and transmit the quantized image representation ŷ. The decoder first recovers \hat{z} from the compressed signal. It then uses hₛ to obtain σ, which provides it with the correct probability estimates to successfully recover ŷ as well. It then feeds ŷ into gₛ to obtain the reconstructed image.

When the hyper encoder and hyper decoder are added to the image compression network, the spatial redundancies of the quantized latent ŷ are reduced. The rightmost image (that is, the latents y 330) in FIG. 3 correspond to the quantized latent when hyper encoder/decoder are used. Compared to middle right image (that is, the standard deviations σ 320), the spatial redundancies are significantly reduced, as the samples of the quantized latent are less correlated.

### 2.3.4 Context Model

Although the hyper prior model improves the modelling of the probability distribution of the quantized latent y, additional improvement can be obtained by utilizing an autoregressive model that predicts quantized latents from their causal context (Context Model).

The term auto-regressive means that the output of a process is later used as input to it. For example, the context model subnetwork generates one sample of a latent, which is later used as input to obtain the next sample.

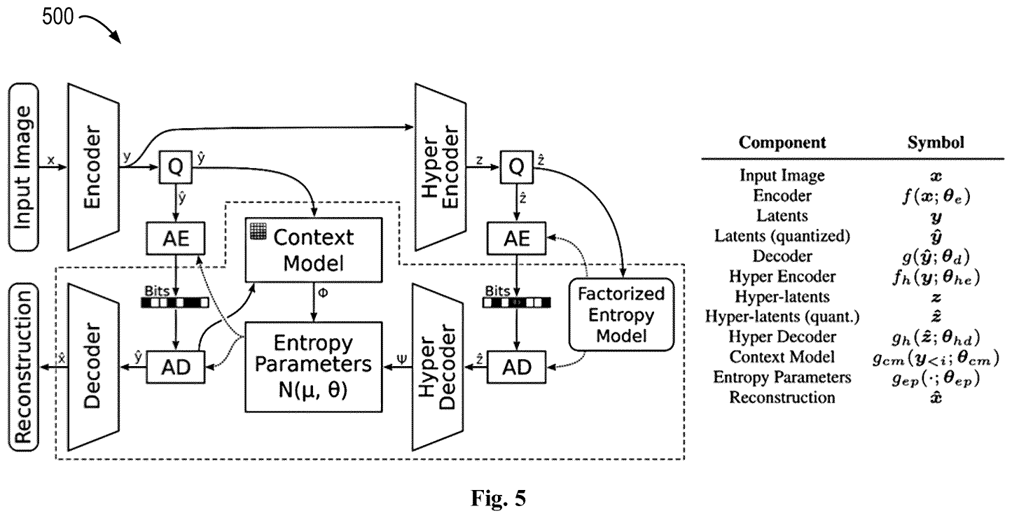

FIG. 5 is a schematic diagram 500 illustrating an example combined model configured to jointly optimize a context model along with a hyperprior and the autoencoder. The combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The dashed region corresponds to the components that are executed by the receiver (e.g, a decoder) to recover an image from a compressed bitstream.

A joint architecture where both hyper prior model subnetwork (hyper encoder and hyper decoder) and a context model subnetwork are utilized. The hyper prior and the context model are combined to learn a probabilistic model over quantized latents y, which is then used for entropy coding. As depicted in FIG. 5, the outputs of context subnetwork and hyper decoder subnetwork are combined by the subnetwork called Entropy Parameters, which generates the mean μ and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.

Typically the latent samples are modeled as gaussian distribution or gaussian mixture models (not limited to). In FIG. 5, the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

### 2.3.5 Gained Variational Autoencoders (G-VAE)

Typically, neural network-based image/video compression methodologies need to train multiple models to adapt to different rates. Gained variational autoencoders (G-VAE) is the variational autoencoder with a pair of gain units, which is designed to achieve continuously variable rate adaptation using a single model. It comprises of a pair of gain units, which are typically inserted to the output of encoder and input of decoder. The output of the encoder is defined as the latent representation y∈R^{c*h*w}, where c, h, w represent the number of channels, the height and width of the latent representation. Each channel of the latent representation is denoted as y₍ᵢ₎∈R^{h*w}, where i=0, 1, . . . , c−1. A pair of gain units include a gain matrix M∈R^{c*n} and an inverse gain matrix, where n is the number of gain vectors. The gain vector can be denoted as mₛ={αₛ₍₀₎, αₛ₍₁₎, . . . , α_{s(c-1)}}, αₛ₍ᵢ₎∈R where s denotes the index of the gain vectors in the gain matrix.

The motivation of gain matrix is similar to the quantization table in JPEG by controlling the quantization loss based on the characteristics of different channels. To apply the gain matrix to the latent representation, each channel is multiplied with the corresponding value in a gain vector.

$${\overline{y}}_{s} = y ⊙ {m}_{s}$$

Where ⊙ is channel-wise multiplication, i.e., y̅ₛ₍ᵢ₎=y₍ᵢ₎×αₛ₍ᵢ₎, and αₛ₍ᵢ₎ is the i-th gain value in the gain vector mₛ. The inverse gain matrix used at the decoder side can be denoted as M′∈R^{c*n}, which consists of n inverse gain vectors, i.e., M′={δₛ₍₀₎, δₛ₍₁₎, . . . , δ_{s(c-1)}}, δₛ₍ᵢ₎∈R. The inverse gain process is expressed as

$${y}_{s}^{′} = \hat{y} ⊙ {m}_{s}^{′}$$

where ŷ is the decoded quantized latent representation and yₛ′ is the inversely gained quantized latent representation, which will be fed into the synthesis network.

To achieve continuous variable rate adjustment, interpolation is used between vectors. Given two pairs of gain vectors {mₜ, mₜ′} and {mᵣ, mᵣ′}, the interpolated gain vector can be obtained via the following equations.

$${m}_{v} = [ {( {m}_{r} )}^{l} \cdot {( {m}_{t} )}^{1 - l} ]$$

$${m}_{v}^{′} = [ {( {m}_{r}^{′} )}^{l} \cdot {( {m}_{t}^{′} )}^{1 - l} ]$$

where l∈R is an interpolation coefficient, which controls the corresponding bit rate of the generated gain vector pair. Since l is a real number, an arbitrary bit rate between the given two gain vector pairs can be achieved.

### 2.3.6 the Encoding Process Using Joint Auto-Regressive Hyper Prior Model

The FIG. 5. corresponds to the compression method using joint auto-regressive hyper prior model. In this section and the next, the encoding and decoding processes will be described separately.

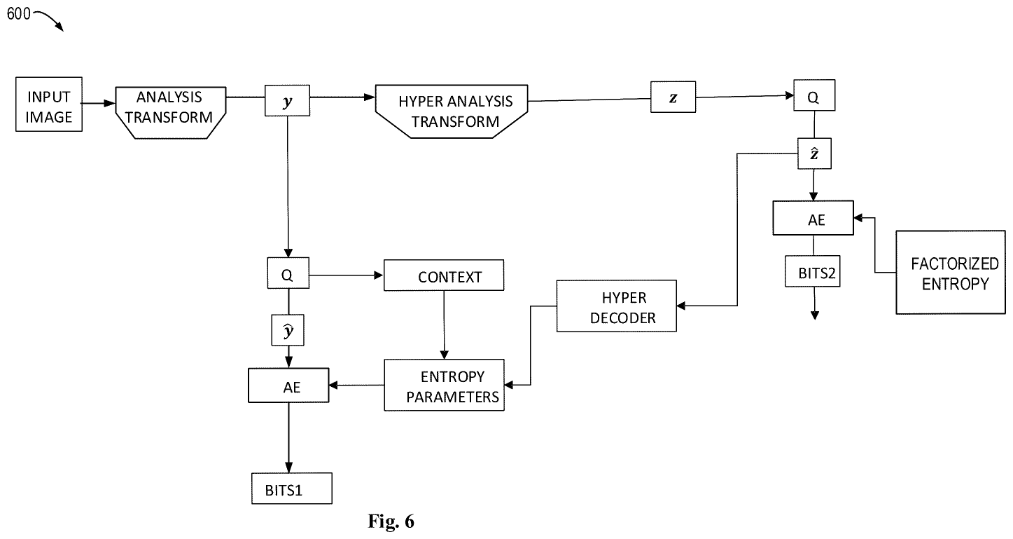

FIG. 6 depicts an encoding process 600. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the \grave{y} into a bitstream (bits1) one by one, in a sequential order.

The modules hyper encoder, context, hyper decoder, and entropy parameters subnetworks are used to estimate the probability distributions of the samples of the quantized latent ŷ. the latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter σ is its standard deviation (or variance, or scale). In order to define a gaussian distribution, the mean and the variance need to be determined. The entropy parameters module are used to estimate the mean and the variance values.

The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or ŷ[i,j] depending on the dimensions of the matrix ŷ. The samples ŷ[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent \grave{y} into bitstream (bits1).

Finally the first and the second bitstream are transmitted to the decoder as result of the encoding process.

It is noted that the other names can be used for the modules described above.

In the above description, the all of the elements in FIG. 6 are collectively called encoder. The analysis transform that converts the input image into latent representation is also called an encoder (or auto-encoder).

### 2.3.7 the Decoding Process Using Joint Auto-Regressive Hyper Prior Model

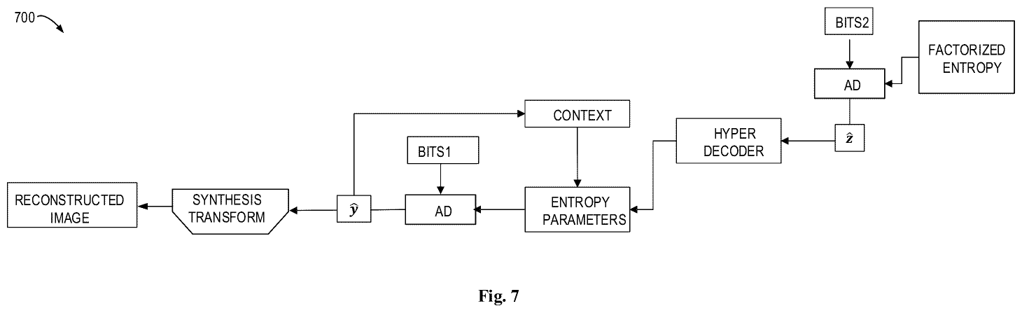

FIG. 7 depicts a decoding process 700 separately corresponding to the encoding process 600.

In the decoding process 700, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore, the exact same probability distributions can be obtained in the decoder (as in encoder), which is essential for reconstructing the quantized latent ŷ without any loss. As a result, the identical version of the quantized latent ŷ that was obtained in the encoder can be obtained in the decoder.

After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization.

Finally the fully reconstructed quantized latent ŷ is input to the synthesis transform (denoted as decoder in FIG. 7) module to obtain the reconstructed image.

In the above description, the all of the elements in FIG. 7 are collectively called decoder. The synthesis transform that converts the quantized latent into reconstructed image is also called a decoder (or auto-decoder).

### 2.4. Neural Networks for Video Compression

Similar to conventional video coding technologies, neural image compression serves as the foundation of intra compression in neural network-based video compression, thus development of neural network-based video compression technology comes later than neural network-based image compression but needs far more efforts to solve the challenges due to its complexity. Starting from 2017, a few researchers have been working on neural network-based video compression schemes. Compared with image compression, video compression needs efficient methods to remove inter-picture redundancy. Inter-picture prediction is then a crucial step in these works. Motion estimation and compensation is widely adopted but is not implemented by trained neural networks until recently.

Studies on neural network-based video compression can be divided into two categories according to the targeted scenarios: random access and the low-latency. In random access case, it requires the decoding can be started from any point of the sequence, typically divides the entire sequence into multiple individual segments and each segment can be decoded independently. In low-latency case, it aims at reducing decoding time thereby usually merely temporally previous frames can be used as reference frames to decode subsequent frames.

### 2.4.1 Low-Latency

A video compression scheme with trained neural networks is proposed. The video sequence frames are split into blocks and each block will choose one from two available modes, either intra coding or inter coding. If intra coding is selected, there is an associated auto-encoder to compress the block. If inter coding is selected, motion estimation and compensation are performed with tradition methods and a trained neural network will be used for residue compression. The outputs of auto-encoders are directly quantized and coded by the Huffman method.

Another neural network-based video coding scheme with PixelMotionCNN is proposed. The frames are compressed in the temporal order, and each frame is split into blocks which are compressed in the raster scan order. Each frame will firstly be extrapolated with the preceding two reconstructed frames. When a block is to be compressed, the extrapolated frame along with the context of the current block are fed into the PixelMotionCNN to derive a latent representation. Then the residues are compressed by the variable rate image scheme. This scheme performs on par with H.264.

A real-sense end-to-end neural network-based video compression framework is proposed, in which all the modules are implemented with neural networks. The scheme accepts current frame and the prior reconstructed frame as inputs and optical flow will be derived with a pre-trained neural network as the motion information. The motion information will be warped with the reference frame followed by a neural network generating the motion compensated frame. The residues and the motion information are compressed with two separate neural auto-encoders. The whole framework is trained with a single rate-distortion loss function. It achieves better performance than H.264.

An advanced neural network-based video compression scheme is proposed. It inherits and extends traditional video coding schemes with neural networks with the following major features: 1) using only one auto-encoder to compress motion information and residues; 2) motion compensation with multiple frames and multiple optical flows; 3) an on-line state is learned and propagated through the following frames over time. This scheme achieves better performance in MS-SSIM than HEVC reference software.

An extended end-to-end neural network-based video compression framework based on is proposed. In this solution, multiple frames are used as references. It is thereby able to provide more accurate prediction of current frame by using multiple reference frames and associated motion information. In addition, motion field prediction is deployed to remove motion redundancy along temporal channel. Postprocessing networks are also introduced in this work to remove reconstruction artifacts from previous processes. The performance is better than and H.265 by a noticeable margin in terms of both PSNR and MS-SSIM.

A scale-space flow is proposed to replace commonly used optical flow by adding a scale parameter based on framework of. It is reportedly achieving better performance than H.264.

It is proposed a multi-resolution representation for optical flows. Concretely, the motion estimation network produces multiple optical flows with different resolutions and let the network to learn which one to choose under the loss function. The performance is slightly improved compared with and better than H.265.

### 2.4.2 Random Access

A neural network-based video compression scheme with frame interpolation is proposed. The key frames are first compressed with a neural image compressor and the remaining frames are compressed in a hierarchical order. They perform motion compensation in the perceptual domain, i.e. deriving the feature maps at multiple spatial scales of the original frame and using motion to warp the feature maps, which will be used for the image compressor. The method is reportedly on par with H.264.

A method for interpolation-based video compression is proposed, wherein the interpolation model combines motion information compression and image synthesis, and the same auto-encoder is used for image and residual.

A neural network-based video compression method based on variational auto-encoders with a deterministic encoder is proposed. Concretely, the model consists of an auto-encoder and an auto-regressive prior. Different from previous methods, this method accepts a group of pictures (GOP) as inputs and incorporates a 3D autoregressive prior by taking into account of the temporal correlation while coding the laten representations. It provides comparative performance as H.265.

### 2.5. Preliminaries

Almost all the natural image/video is in digital format. A grayscale digital image can be represented by x∈ [symbol] ^{m×n}, where [symbol] is the set of values of a pixel, m is the image height and n is the image width. For example, [symbol] ={0, 1, 2, . . . , 255} is a common setting and in this case | [symbol] |=256=2⁸, thus the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x∈ [symbol] ^{m×n×3} with three separate channels storing Red, Green and Blue information. Similar to the 8-bit grayscale image, an uncompressed 8-bit RGB image has 24 bpp. Digital images/videos can be represented in different color spaces. The neural network-based video compression schemes are mostly developed in RGB color space while the traditional codecs typically use YUV color space to represent the video sequences. In YUV color space, an image is decomposed into three channels, namely Y, Cb and Cr, where Y is the luminance component and Cb/Cr are the chroma components. The benefits come from that Cb and Cr are typically down sampled to achieve pre-compression since human vision system is less sensitive to chroma components.

A color video sequence is composed of multiple color images, called frames, to record scenes at different timestamps. For example, in the RGB color space, a color video can be denoted by X={x₀, x₁, . . . , xₜ, . . . , x_{T-1}} where T is the number of frames in this video sequence, x∈ [symbol] ^{m×n}. If m=1080, n=1920, | [symbol] |=2⁸, and the video has 50 frames-per-second (fps), then the data rate of this uncompressed video is 1920×1080×8×3×50=2,488,320,000 bits-per-second (bps), about 2.32 Gbps, which needs a lot storage thereby definitely needs to be compressed before transmission over the internet.

Usually the lossless methods can achieve compression ratio of about 1.5 to 3 for natural images, which is clearly below requirement. Therefore, lossy compression is developed to achieve further compression ratio, but at the cost of incurred distortion. The distortion can be measured by calculating the average squared difference between the original image and the reconstructed image, i.e., mean-squared-error (MSE). For a grayscale image, MSE can be calculated with the following equation.

$$MSE = \frac{{‖ x - \hat{x} ‖}^{2}}{m \times n} \qquad ( 4 )$$

Accordingly, the quality of the reconstructed image compared with the original image can be measured by peak signal-to-noise ratio (PSNR):

$$PSNR = 10 \times {log}_{10} \frac{{( max ( 𝔻 ) )}^{2}}{MSE} \qquad ( 5 )$$

where max( [symbol] ) is the maximal value in [symbol] , e.g., 255 for 8-bit grayscale images. There are other quality evaluation metrics such as structural similarity (SSIM) and multi-scale SSIM (MS-SSIM).

To compare different lossless compression schemes, it is sufficient to compare either the compression ratio given the resulting rate or vice versa. However, to compare different lossy compression methods, it has to take into account both the rate and reconstructed quality. For example, to calculate the relative rates at several different quality levels, and then to average the rates, is a commonly adopted method: the average relative rate is known as Bjontegaard's delta-rate (BD-rate). There are other important aspects to evaluate image/video coding schemes, including encoding/decoding complexity, scalability, robustness, and so on.

### 3. Problems

### 3.1. The Core Problem

As illustrated in FIG. 7, the synthesis network is responsible for the last step of the decoding process, i.e., synthesizing the reconstructed image from the decoded feature maps. The whole decoder is typically comprised of multiple synthesis networks to cover an applicable range of bitrates. The following issues exist in current methodology.

Problem 1. Due to the varied content of image/video content, using a single synthesis network for that specific rate point may not be optimal. For example, the characteristics of screen content are different from natural content images. Using a synthesis network to process screen content images is likely leading to degraded performance.

Problem 2. In some scenarios, the synthesis network is heavy in terms of number of parameters and computational complexity. Therefore, more synthesis networks means more burden on storage space and computational consumption.

### 4. Detailed Solutions

To solve Problem 1, a set of N pretrained subnetwork weights can be trained based on a classification method. For example, classifying the training set into two categories based on if it is screen content; classifying into multiple categories based on the object category (such as people, landscape, buildings etc). In the decoding process, the synthesis network is selected from this set based on current content.

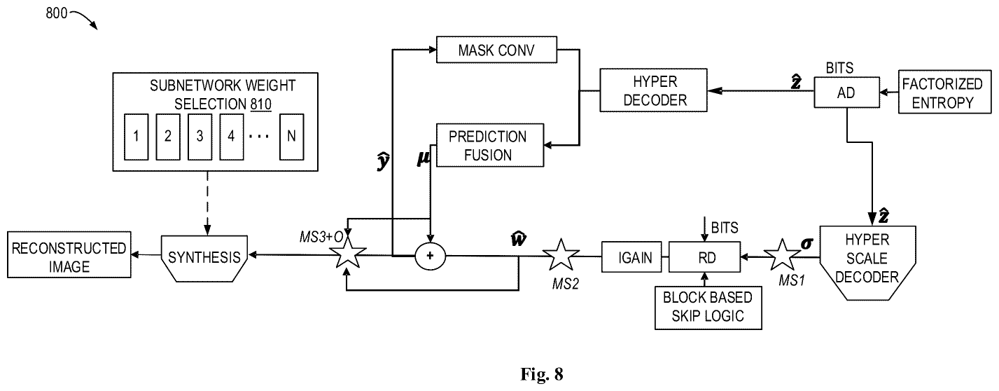

To solve Problem 2, fewer synthesis networks can be used and use entropy coding part, such as the prediction fusion part in FIG. 8, to compensate the potential performance loss.

The detailed embodiments below should be considered as examples to explain general concepts. These embodiments should not be interpreted in a narrow way. Furthermore, these embodiments can be combined in any manner.

### 4.1. Target of Embodiments

The target of embodiments of the disclosure is to improve the coding efficiency and reduce the model size for neural network-based image/video compression.

### 4.2. Core of Embodiments

The synthesis can be selected from a set of multiple pretrained subnetwork weight set. The total number of the synthesis networks could be reduced and more options of prediction in entropy coding part can be used to achieve variable rate coding.

### 4.2.1. Decoding Process

FIG. 8 illustrates a decoding process 800 with an independent subnetwork weight selection 810 for a synthesis network.

According to the disclosure, the decoding operation is performed as follows:
1. Firstly, the factorized entropy model is used to decode the quantized latents, i.e., \hat{z} in FIG. 8.
2. The probability parameters (e.g. variance) generated by the second network are used to generate a quantized residual latent by performing the arithmetic decoding process.
3. The quantized residual latent is inversely gained with the inverse gain unit (iGain) as shown in FIG. 8. The outputs of the inverse gain units are denoted as ŵ.
4. The following steps are performed in a loop until all elements of ŷ are obtained:
   a. A first subnetwork is used to estimate a mean value parameter of a quantized latent (ŷ), using the already obtained samples of ŷ.
   b. The quantized residual latent ŵ and the mean value are used to obtain the next element of ŷ.
5. The synthesis network is selected from the pretrained subnetwork weight set. The index of the synthesis network could be encoded in the bitstreams.
6. After the synthesis network is decided and all of the samples of ŷ are obtained, the reconstructed can be derived.

An exemplary implementation of the embodiments is depicted in the FIG. 8 above (the decoding process). The framework illustrates how to decode luma component and the chroma component could be decoded using the same structure. The first subnetwork comprises the context, prediction and optionally the hyper decoder modules. The second network comprises the hyper scale decoder module. The quantized hyper latent is \hat{z}. The arithmetic decoding process generates the quantized residual latents, which are further fed into the iGain units to obtain the gained quantized residual latents ŵ.

After the residual latent is obtained, a recursive prediction operation is performed to obtain the latent ŷ and ŷᵤᵥ. The following steps describe how to obtain the samples of latent ŷ[:,i,j].
1. An autoregressive context module is used to generate first input of a prediction module using the samples ŷ[:,m,n] where the (m, n) pair are the indices of the samples of the latent that are already obtained.
2. Optionally the second input of the prediction module is obtained by using a hyper decoder and a quantized hyper latent [symbol] .
3. Using the first input and the second input, the prediction module generates the mean value mean[:,i,j].
4. The mean value mean[:,i,j] and the quantized residual latent ŵ[:,i,j] are added together to obtain the latent ŷ[:,i,j].
5. The steps 1-4 are repeated for the next sample.

Whether to and/or how to apply at least one method disclosed in the document may be signaled from the encoder to the decoder, e.g. in the bitstream.

Alternatively, whether to and/or how to apply at least one method disclosed in the document may be determined by the decoder based on coding information, such as dimensions, color format, etc.

Alternative or additionally, the modules named MS1, MS2 or MS3+O (in FIG. 8), might be included in the processing flow. The said modules might perform an operation to their input by multiplying the input with a scalar or adding an adding an additive component to the input to obtain the output. The scalar or the additive component that are used by the said modules might be indicated in a bitstream.

The module named RD or the module named AD in the FIG. 8 might be an entropy decoding module. It might be a range decoder or an arithmetic decoder or the like.

The invention described herein is not limited to the specific combination of the units exemplified in FIG. 8. Some of the modules might be missing and some of the modules might be displaced in processing order. Also, additional modules might be included, such as the postprocessing filters, using reconstructed luma component to help chroma reconstruction in synthesis network, etc.

### 4.2.2. Reduce the Number of Synthesis Transform

Usually multiple synthesis transforms are involved for different bit rate ranges to support continuously variable rate. However, it is storage consuming and computationally heavy. It is always beneficial to reduce the number of synthesis networks used in the decoding process in terms of storage efficiency and computationally efficient. To achieve this goal, the number of synthesis networks is reduced, for example, from 4 to 3 in some cases. To compensate the possible performance degradation and support variable rate coding, there are more options for prediction/entropy coding part.

### 4.3. Examples Embodiments

The detailed embodiments below should be considered as examples to explain general concepts. These embodiments should not be interpreted in a narrow way. Furthermore, these embodiments can be combined in any manner.
1. In one example, the synthesis transform weights can be selected from a set comprised of N1 subnetwork weights. The prediction fusion network, as shown in FIG. 8, weights can be selected from a set of N2 subnetwork weights.
2. In one example, one synthesis might be trained for screen content, another for natural content, whereas a single entropy coding network can be utilized for both.
3. In one example, there may be reduced number of synthesis networks. To support continuously variable rate coding, the prediction fusion part can be enhanced by changing the network architecture, such as the number of convolutional layers, resampling layer types, activation layer types.

### 5. Further Embodiments

### 1. Decoder:

a) An independent subnetwork weight selection scheme for neural network-based image or video compression.
b) A continuously rate coding scheme using fewer synthesis networks wherein the entropy coding part is enhanced to compensate for the incurred performance drop.

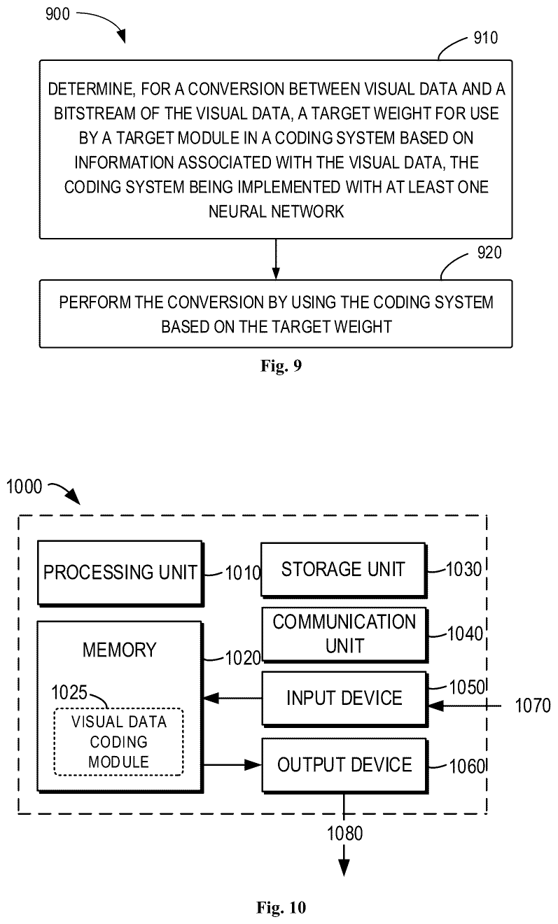

FIG. 9 illustrates a flowchart of a method 900 for visual data processing in accordance with embodiments of the present disclosure. The method 900 is implemented for a conversion between visual data and a bitstream of the visual data.

At block 910, a target weight for use by a target module in a coding system is determined based on information associated with the visual data. The coding system is implemented with at least one neural network (NN). For example, the visual data may be an image or a video. The coding system may be an end-to-end image or video compression system. For example, the coding system may perform the encoding process 600 in FIG. 6 and/or the decoding process 800 in FIG. 8.

At block 920, the conversion is performed by using the coding system based on the target weight. In some embodiments, the conversion comprises decoding the visual data from the bitstream. Alternatively, or in addition, in some embodiments, the conversion comprises encoding the visual data into the bitstream.

The method 900 enables determining a weight for a module in the coding system based on information associated with the visual data such as visual data content. In this way, the performance of the module can be improved. The coding effectiveness and coding efficiency of the coding system can thus be improved.

In some embodiments, the information associated with the visual data comprises at least one of: a content of the visual data, or a category of an object of the visual data. For example, the category of the object comprises at least one of: people, landscape, or building. The content of the visual data may comprise one of: a screen content, or a natural content.

In some embodiments, the target weight is selected from a plurality of candidate weights, the plurality of candidate weights being determined by training at least one synthesis module based on training datasets associated with at least one of: a plurality of contents of the visual data, or a plurality of categories of the object of the visual data, the at least one synthesis module being used to determine a reconstruction of the visual data. In some example embodiments, the candidate weights are synthesis transform weights. The target synthesis transform weight may be selected from a set of subnetwork weights trained based on a classification. For example, the training datasets may be classified into two categories based on if it is screen content. For another example, the training datasets may be classified into a plurality of categories based on the object category. In the decoding process, the target module such as the synthesis network may be selected from the set of pretrained weights based on the current content of the visual data. In some example embodiments, one synthesis may be trained for screen content, another synthesis may be trained for natural content. A single entropy coding network is utilized for both of these synthesis networks.

In some embodiments, performing the conversion comprises: determining an index of the target module from the bitstream; determining the target module from a plurality of candidate modules based on the index, the plurality of candidate modules being trained based on the plurality of candidate weights; and performing the conversion by determining a reconstruction of the visual data using the target module based on the target weight and a representation of the visual data. For example, the target synthesis network may be selected from the pretrained subnetwork weight set. The index of the target synthesis network such as the index 1, 2, 3, 4 . . . or N as shown in FIG. 8 may be encoded in the bitstream.

In some embodiments, the target weight comprises a set of weight values, and determining the reconstruction of the visual data comprises: determining the reconstruction of the visual data by using the target module based on the set of weight values and a plurality of samples of the representation of the visual data.

In some embodiments, the method 900 further comprises: determining the index of the target module based on the information associated with the visual data.

In some embodiments, the first number of the plurality of candidate modules is less than the second number of candidate modules in a further coding system, the further coding system coding the visual data without determining the target weight. In other words, fewer synthesis networks may be used. For example, the number of synthesis networks is reduced, for example, from 4 to 3 in some cases. More options of prediction in entropy coding part may be used to achieve variable rate coding. In this way, the coding efficiency can be improved. In addition, the model size for the neural network-based image or video compression can be reduced.

In some embodiments, performing the conversion comprises: determining at least one sample of a representation of the visual data by using a prediction module in the coding system; and determining a reconstruction of the visual data by using the target module based on the target weight and the at least one sample.

In some embodiments, determining the at least one sample comprises: determining a prediction weight from a plurality of candidate prediction weights based on the information associated with the visual data; and determining the at least one sample by using the prediction module based on the prediction weight.

In some embodiments, the method 900 further comprises: updating at least one architecture of a first architecture of a prediction module in the coding system or a second architecture of an entropy coding module in the coding system by amending at least one of: the number of convolutional layers in the at least one architecture, a type of a resampling layer in the at least one architecture, or a type of an activation layer in the at least one architecture. For example, there may be reduced number of synthesis networks. To support continuously variable rate coding, the prediction fusion part may be enhanced by changing the network architecture, such as the number of convolutional layers, resampling layer types, activation layer types, or the like. In this way, a continuously rate coding scheme using fewer synthesis networks is achieved, where the entropy coding part is enhanced to compensate for the incurred performance drop.

In some embodiments, the coding system comprises a factorized entropy module, a hyper scale coding module, a context module and the target module implemented with the at least one neural network, and wherein performing the conversion comprises: determining a first representation of the visual data based on the bitstream by using the factorized entropy module; determining a first probability parameter of the visual data based on the first representation by using the hyper scale coding module; determining a residual representation of the visual data based on the first probability parameter and the bitstream; determining a second representation of the visual data based on the first representation and the residual representation by using the context module; and determining a reconstruction of the visual data based on the second representation by using the target module based on the target weight.

In some embodiments, the residual representation is determined further based on a gain module.

In some embodiments, the residual representation comprises a quantized residual representation.

In some embodiments, the context module comprises an autoregressive context module and a prediction module, and determining the second representation comprises: determining a first intermediate representation based on a first sample of the second representation by using the autoregressive context module; determining a second probability parameter of the visual data at least based on the first intermediate representation by using the prediction module; and determining a second sample of the second representation based on the second probability parameter and the residual representation.

In some embodiments, the context module further comprises a hyper coding module, and determining the second probability parameter comprises: determining a second intermediate representation based on the first representation by using the hyper coding module; and determining the second probability parameter based on the first and second intermediate representations by using the prediction module.

In some embodiments, the second probability parameter is determined by the prediction module further based on a prediction weight selected from a plurality of candidate prediction weights.

In some embodiments, the visual data comprises a luma component and a chroma component. The luma component and the chroma component may be coded using a same structure, such as the structure shown in FIG. 8.

In some embodiments, the coding system further comprises a scaling module for scaling an input of the scaling module based on a scaling factor. In some embodiments, the scaling factor is included in the bitstream.

In some embodiments, the coding system further comprises an addition module for adding an addition factor to an input of the addition module. In some embodiments, the addition factor is included in the bitstream.

In some embodiments, the coding system further comprises at least one of: an entropy coding module, a range coding module, or an arithmetic coding module.

In some embodiments, the target module comprises a synthesis module for determining a reconstruction of the visual data.

In some embodiments, further information regarding applying the method is included in the bitstream. In some embodiments, the further information indicates at least one of: whether to apply the method, or how to apply the method.

In some embodiments, the method 900 further comprises: determining the further information based on coding information of the visual data.

In some embodiments, the coding information comprises at least one of: a dimension of the visual data, or a color format of the visual data.

According to further embodiments of the present disclosure, a non-transitory computer-readable recording medium is provided. The non-transitory computer-readable recording medium stores a bitstream of a video which is generated by a method performed by an apparatus for visual data processing. In the method, a target weight for use by a target module in a coding system is determined based on information associated with the visual data. The coding system is implemented with at least one neural network. The bitstream is generated by using the coding system based on the target weight.

According to still further embodiments of the present disclosure, a method for storing bitstream of visual data is provided. In the method, a target weight for use by a target module in a coding system is determined based on information associated with the visual data. The coding system is implemented with at least one neural network. The bitstream is generated by using the coding system based on the target weight. The bitstream is stored in a non-transitory computer-readable recording medium.

Implementations of the present disclosure can be described in view of the following clauses, the features of which can be combined in any reasonable manner.

Clause 1. A method for visual data processing, comprising: determining, for a conversion between visual data and a bitstream of the visual data, a target weight for use by a target module in a coding system based on information associated with the visual data, the coding system being implemented with at least one neural network; and performing the conversion by using the coding system based on the target weight.

Clause 2. The method of clause 1, wherein the information associated with the visual data comprises at least one of: a content of the visual data, or a category of an object of the visual data.

Clause 3. The method of clause 2, wherein the category of the object comprises at least one of: people, landscape, or building.

Clause 4. The method of clause 2, wherein the content of the visual data comprises one of: a screen content, or a natural content.

Clause 5. The method of any of clauses 2-4, wherein the target weight is selected from a plurality of candidate weights, the plurality of candidate weights being determined by training at least one synthesis module based on training datasets associated with at least one of: a plurality of contents of the visual data, or a plurality of categories of the object of the visual data, the at least one synthesis module being used to determine a reconstruction of the visual data.

Clause 6. The method of any of clauses 1-5, wherein performing the conversion comprises: determining an index of the target module from the bitstream; determining the target module from a plurality of candidate modules based on the index, the plurality of candidate modules being trained based on the plurality of candidate weights; and performing the conversion by determining a reconstruction of the visual data using the target module based on the target weight and a representation of the visual data.

Clause 7. The method of clause 6, wherein the target weight comprises a set of weight values, and determining the reconstruction of the visual data comprises: determining the reconstruction of the visual data by using the target module based on the set of weight values and a plurality of samples of the representation of the visual data.

Clause 8. The method of clause 6, further comprising: determining the index of the target module based on the information associated with the visual data.

Clause 9. The method of any of clauses 6-8, wherein the first number of the plurality of candidate modules is less than the second number of candidate modules in a further coding system, the further coding system coding the visual data without determining the target weight.

Clause 10. The method of any of clauses 1-9, wherein performing the conversion comprises: determining at least one sample of a representation of the visual data by using a prediction module in the coding system; and determining a reconstruction of the visual data by using the target module based on the target weight and the at least one sample.

Clause 11. The method of clause 10, wherein determining the at least one sample comprises: determining a prediction weight from a plurality of candidate prediction weights based on the information associated with the visual data; and determining the at least one sample by using the prediction module based on the prediction weight.

Clause 12. The method of any of clauses 1-11, further comprising: updating at least one architecture of a first architecture of a prediction module in the coding system or a second architecture of an entropy coding module in the coding system by amending at least one of: the number of convolutional layers in the at least one architecture, a type of a resampling layer in the at least one architecture, or a type of an activation layer in the at least one architecture.

Clause 13. The method of any of clauses 1-12, wherein the coding system comprises a factorized entropy module, a hyper scale coding module, a context module and the target module implemented with the at least one neural network, and wherein performing the conversion comprises: determining a first representation of the visual data based on the bitstream by using the factorized entropy module; determining a first probability parameter of the visual data based on the first representation by using the hyper scale coding module; determining a residual representation of the visual data based on the first probability parameter and the bitstream; determining a second representation of the visual data based on the first representation and the residual representation by using the context module; and determining a reconstruction of the visual data based on the second representation by using the target module based on the target weight.

Clause 14. The method of clause 13, wherein the residual representation is determined further based on a gain module.

Clause 15. The method of clause 13 or clause 14, wherein the residual representation comprises a quantized residual representation.

Clause 16. The method of any of clauses 13-16, wherein the context module comprises an autoregressive context module and a prediction module, and determining the second representation comprises: determining a first intermediate representation based on a first sample of the second representation by using the autoregressive context module; determining a second probability parameter of the visual data at least based on the first intermediate representation by using the prediction module; and determining a second sample of the second representation based on the second probability parameter and the residual representation.

Clause 17. The method of clause 16, wherein the context module further comprises a hyper coding module, and determining the second probability parameter comprises: determining a second intermediate representation based on the first representation by using the hyper coding module; and determining the second probability parameter based on the first and second intermediate representations by using the prediction module.

Clause 18. The method of clause 16 or clause 17, wherein the second probability parameter is determined by the prediction module further based on a prediction weight selected from a plurality of candidate prediction weights.

Clause 19. The method of any of clauses 1-18, wherein the visual data comprises a luma component and a chroma component.

Clause 20. The method of any of clauses 1-19, wherein the coding system further comprises a scaling module for scaling an input of the scaling module based on a scaling factor.

Clause 21. The method of clause 20, wherein the scaling factor is included in the bitstream.

Clause 22. The method of any of clauses 1-21, wherein the coding system further comprises an addition module for adding an addition factor to an input of the addition module.

Clause 23. The method of clause 22, wherein the addition factor is included in the bitstream.

Clause 24. The method of any of clauses 1-23, wherein the coding system further comprises at least one of: an entropy coding module, a range coding module, or an arithmetic coding module.

Clause 25. The method of any of clauses 1-24, wherein the target module comprises a synthesis module for determining a reconstruction of the visual data.

Clause 26. The method of any of clauses 1-25, wherein further information regarding applying the method is included in the bitstream.

Clause 27. The method of clause 26, wherein the further information indicates at least one of: whether to apply the method, or how to apply the method.

Clause 28. The method of clause 26 or clause 27, further comprising: determining the further information based on coding information of the visual data.

Clause 29. The method of clause 28, wherein the coding information comprises at least one of: a dimension of the visual data, or a color format of the visual data.

Clause 30. The method of any of clauses 1-29, wherein the conversion comprises decoding the visual data from the bitstream.

Clause 31. The method of any of clauses 1-29, wherein the conversion comprises encoding the visual data into the bitstream.

Clause 32. An apparatus for visual data processing comprising a processor and a non-transitory memory with instructions thereon, wherein the instructions upon execution by the processor, cause the processor to perform a method in accordance with any of clauses 1-31.

Clause 33. A non-transitory computer-readable storage medium storing instructions that cause a processor to perform a method in accordance with any of clauses 1-31.

Clause 34. A non-transitory computer-readable recording medium storing a bitstream of a video which is generated by a method performed by an apparatus for visual data processing, wherein the method comprises: determining a target weight for use by a target module in a coding system based on information associated with the visual data, the coding system being implemented with at least one neural network; and generating the bitstream by using the coding system based on the target weight.

Clause 35. A method for storing a bitstream of a video, comprising: determining a target weight for use by a target module in a coding system based on information associated with the visual data, the coding system being implemented with at least one neural network; generating the bitstream by using the coding system based on the target weight; and storing the bitstream in a non-transitory computer-readable recording medium.

### Example Device

FIG. 10 illustrates a block diagram of a computing device 1000 in which various embodiments of the present disclosure can be implemented. The computing device 1000 may be implemented as or included in the source device 110 (or the data encoder 114) or the destination device 120 (or the data decoder 124).

It would be appreciated that the computing device 1000 shown in FIG. 10 is merely for purpose of illustration, without suggesting any limitation to the functions and scopes of the embodiments of the present disclosure in any manner.

As shown in FIG. 10, the computing device 1000 includes a general-purpose computing device 1000. The computing device 1000 may at least comprise one or more processors or processing units 1010, a memory 1020, a storage unit 1030, one or more communication units 1040, one or more input devices 1050, and one or more output devices 1060.

In some embodiments, the computing device 1000 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1000 can support any type of interface to a user (such as “wearable” circuitry and the like).

The processing unit 1010 may be a physical or virtual processor and can implement various processes based on programs stored in the memory 1020. In a multi-processor system, multiple processing units execute computer executable instructions in parallel so as to improve the parallel processing capability of the computing device 1000. The processing unit 1010 may also be referred to as a central processing unit (CPU), a microprocessor, a controller or a microcontroller.

The computing device 1000 typically includes various computer storage medium. Such medium can be any medium accessible by the computing device 1000, including, but not limited to, volatile and non-volatile medium, or detachable and non-detachable medium. The memory 1020 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1030 may be any detachable or non-detachable medium and may include a machine-readable medium such as a memory, flash memory drive, magnetic disk or another other media, which can be used for storing information and/or data and can be accessed in the computing device 1000.

The computing device 1000 may further include additional detachable/non-detachable, volatile/non-volatile memory medium. Although not shown in FIG. 10, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1040 communicates with a further computing device via the communication medium. In addition, the functions of the components in the computing device 1000 can be implemented by a single computing cluster or multiple computing machines that can communicate via communication connections. Therefore, the computing device 1000 can operate in a networked environment using a logical connection with one or more other servers, networked personal computers (PCs) or further general network nodes.

The input device 1050 may be one or more of a variety of input devices, such as a mouse, keyboard, tracking ball, voice-input device, and the like. The output device 1060 may be one or more of a variety of output devices, such as a display, loudspeaker, printer, and the like. By means of the communication unit 1040, the computing device 1000 can further communicate with one or more external devices (not shown) such as the storage devices and display device, with one or more devices enabling the user to interact with the computing device 1000, or any devices (such as a network card, a modem and the like) enabling the computing device 1000 to communicate with one or more other computing devices, if required. Such communication can be performed via input/output (I/O) interfaces (not shown).

In some embodiments, instead of being integrated in a single device, some or all components of the computing device 1000 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1000 may be used to implement visual data encoding/decoding in embodiments of the present disclosure. The memory 1020 may include one or more visual data coding modules 1025 having one or more program instructions. These modules are accessible and executable by the processing unit 1010 to perform the functionalities of the various embodiments described herein.

In the example embodiments of performing visual data encoding, the input device 1050 may receive visual data as an input 1070 to be encoded. The visual data may be processed, for example, by the visual data coding module 1025, to generate an encoded bitstream. The encoded bitstream may be provided via the output device 1060 as an output 1080.

In the example embodiments of performing visual data decoding, the input device 1050 may receive an encoded bitstream as the input 1070. The encoded bitstream may be processed, for example, by the visual data coding module 1025, to generate decoded visual data. The decoded visual data may be provided via the output device 1060 as the output 1080.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for visual data processing, comprising:
determining, for a conversion between visual data and a bitstream of the visual data, a target weight for use by a target module in a coding system based on information associated with the visual data, the coding system being implemented with at least one neural network; and
performing the conversion by using the coding system based on the target weight.

2. The method of claim 1, wherein the information associated with the visual data comprises at least one of:
a content of the visual data, or
a category of an object of the visual data.

3. The method of claim 2, wherein the category of the object comprises at least one of: people, landscape, or building, and/or
wherein the content of the visual data comprises one of: a screen content, or a natural content, and/or
wherein the target weight is selected from a plurality of candidate weights, the plurality of candidate weights being determined by training at least one synthesis module based on training datasets associated with at least one of: a plurality of contents of the visual data, or a plurality of categories of the object of the visual data, the at least one synthesis module being used to determine a reconstruction of the visual data.

4. The method of claim 1, wherein performing the conversion comprises:
determining an index of the target module from the bitstream;
determining the target module from a plurality of candidate modules based on the index, the plurality of candidate modules being trained based on the plurality of candidate weights; and
performing the conversion by determining a reconstruction of the visual data using the target module based on the target weight and a representation of the visual data.

5. The method of claim 4, wherein the target weight comprises a set of weight values, and determining the reconstruction of the visual data comprises:
determining the reconstruction of the visual data by using the target module based on the set of weight values and a plurality of samples of the representation of the visual data.

6. The method of claim 4, further comprising:
determining the index of the target module based on the information associated with the visual data.

7. The method of claim 4, wherein the first number of the plurality of candidate modules is less than the second number of candidate modules in a further coding system, the further coding system coding the visual data without determining the target weight.

8. The method of claim 1, wherein performing the conversion comprises:
determining at least one sample of a representation of the visual data by using a prediction module in the coding system; and
determining a reconstruction of the visual data by using the target module based on the target weight and the at least one sample,
wherein determining the at least one sample comprises:
determining a prediction weight from a plurality of candidate prediction weights based on the information associated with the visual data; and
determining the at least one sample by using the prediction module based on the prediction weight.

9. The method of claim 1, further comprising:
updating at least one architecture of a first architecture of a prediction module in the coding system or a second architecture of an entropy coding module in the coding system by amending at least one of:
the number of convolutional layers in the at least one architecture,
a type of a resampling layer in the at least one architecture, or
a type of an activation layer in the at least one architecture.

10. The method of claim 1, wherein the coding system comprises a factorized entropy module, a hyper scale coding module, a context module and the target module implemented with the at least one neural network, and
wherein performing the conversion comprises:
determining a first representation of the visual data based on the bitstream by using the factorized entropy module;
determining a first probability parameter of the visual data based on the first representation by using the hyper scale coding module;
determining a residual representation of the visual data based on the first probability parameter and the bitstream;
determining a second representation of the visual data based on the first representation and the residual representation by using the context module; and
determining a reconstruction of the visual data based on the second representation by using the target module based on the target weight.

11. The method of claim 10, wherein the residual representation is determined further based on a gain module, and/or
wherein the residual representation comprises a quantized residual representation.

12. The method of claim 10, wherein the context module comprises an autoregressive context module and a prediction module, and determining the second representation comprises:
determining a first intermediate representation based on a first sample of the second representation by using the autoregressive context module;
determining a second probability parameter of the visual data at least based on the first intermediate representation by using the prediction module; and
determining a second sample of the second representation based on the second probability parameter and the residual representation.

13. The method of claim 10, wherein the context module further comprises a hyper coding module, and determining the second probability parameter comprises:
determining a second intermediate representation based on the first representation by using the hyper coding module; and
determining the second probability parameter based on the first and second intermediate representations by using the prediction module, and/or
wherein the second probability parameter is determined by the prediction module further based on a prediction weight selected from a plurality of candidate prediction weights.

14. The method of claim 1, wherein the visual data comprises a luma component and a chroma component, and/or
wherein the coding system further comprises a scaling module for scaling an input of the scaling module based on a scaling factor, wherein the scaling factor is included in the bitstream, and/or
wherein the coding system further comprises an addition module for adding an addition factor to an input of the addition module, wherein the addition factor is included in the bitstream, and/or
wherein the coding system further comprises at least one of: an entropy coding module, a range coding module, or an arithmetic coding module, and/or
wherein the target module comprises a synthesis module for determining a reconstruction of the visual data.

15. The method of claim 1, wherein further information regarding applying the method is included in the bitstream, wherein the further information indicates at least one of: whether to apply the method, or how to apply the method, and/or
wherein the further information is determined based on coding information of the visual data, wherein the coding information comprises at least one of: a dimension of the visual data, or a color format of the visual data.

16. The method of claim 1, wherein the conversion comprises decoding the visual data from the bitstream.

17. The method of claim 1, wherein the conversion comprises encoding the visual data into the bitstream.

18. An apparatus for visual data processing comprising a processor and a non-transitory memory with instructions thereon, wherein the instructions upon execution by the processor, cause the processor to:
determine, for a conversion between visual data and a bitstream of the visual data, a target weight for use by a target module in a coding system based on information associated with the visual data, the coding system being implemented with at least one neural network; and
perform the conversion by using the coding system based on the target weight.

19. A non-transitory computer-readable storage medium storing instructions that cause a processor to
determine, for a conversion between visual data and a bitstream of the visual data, a target weight for use by a target module in a coding system based on information associated with the visual data, the coding system being implemented with at least one neural network; and
perform the conversion by using the coding system based on the target weight.

20. A non-transitory computer-readable recording medium storing a bitstream of visual data which is generated by a method performed by an apparatus for visual data processing, wherein the method comprises:
determining a target weight for use by a target module in a coding system based on information associated with the visual data, the coding system being implemented with at least one neural network; and
generating the bitstream by using the coding system based on the target weight.
